(19) United States
(12) Patent Application Publication
(10) Pub. No.: US 2026/0365211 A1
(43) Pub. Date: Nov. 19, 2026

(54) PORTABLE RAIL INSPECTION PORTAL TO CAPTURE HIGH RESOLUTION IMAGES OF A MOVING TRAIN

(71) Applicants: JEFFREY R. NECCIAI, JACKSONVILLE, FL (US); EDWARD BUSCHELMAN, JACKSONVILLE, FL (US); CHARLES FERRY, JACKSONVILLE, FL (US)

(72) Inventors: JEFFREY R. NECCIAI, JACKSONVILLE, FL (US); EDWARD BUSCHELMAN, JACKSONVILLE, FL (US); CHARLES FERRY, JACKSONVILLE, FL (US)

(21) Appl. No.: 19/211,923

(22) Filed: May 19, 2025

(51) Int. Cl. B61L 27/57; B61L 25/02; H04N 23/90

(52) U.S. Cl. CPC B61L 27/57; B61L 25/021; H04N 23/90

(57) ABSTRACT

Train inspection is critical to ensure that the train does not derail. A derailment causes property damage and possibly a loss of life. The ability to place portable inspection equipment that will capture high resolution images of a moving train and provides the ability to perform visual inspections of the train remotely is both cost-effective and practical. In addition, the inclusion of Artificial Intelligence/Machine Learning (AI/ML) to assist the operator(s) by automatically identifying anomalies and defects on the train helps to ensure safety.

### BACKGROUND OF THE INVENTION

### A. Field of the Invention

Trains crisscross the county and are used to transport goods. Trains are comprised of multiple cars and travel on designated routes over tracks using wheels, which rest of the truck of a train. The cars are joined together using couplers; there are many types of couplers in use for this means of transport. It is important for the safe transport of trains that the cars remain coupled. If there is a failure of the coupler or the failure of a wheel of a train, the train could derail and cause serious personal injury or property damage.

It is important to evaluate the integrity of the wheels of the train and the coupler system while the train is moving and other components of the train car. At times it is desirable to be able to inspect various trains in remote locations with the intention of not leaving the testing equipment in that area for the long term.

The current application positions a pair of stanchions that support lighting equipment and cameras. The stanchions are placed a minimum distance from the sides of the train to capture images of sides of the train car and images of the train wheels as the train passes by these stanchions.

Additionally, a plurality of cameras are placed on the tracks to capture images of the underside of the train as it moves on the tracks; these cameras will take high speed images of the components on the underside of each of the train cars.

Software is employed that will incorporate artificial intelligence to analyze the captured images to detect anomalies in the components of the side of the train car, the wheels of each train car and the underside components of the train car.

PRIOR ART

The current applicants own a patent that teaches a fixed railway inspection portal, Device to Capture High Resolution Images of a Train as it Passes Through an Inspection Portal, Buschelman, U.S. Pat. No. 11,974,035 (Date of Issue Apr. 30, 2024). This prior art reference teaches a stationary portal through which a train will pass. As the train moves through the portal high resolution images of all surfaces and sides are captured.

The present application uses the same technology, but the current application is designed to be portable and moved from location to location. In the prior Patent portability is not a feature.

### BRIEF SUMMARY OF THE INVENTION

This is a portable visual inspection device to inspect the structural integrity of the components of both the underside of each train car as each train car passes over this device and the lower one-third of each railroad train car. The application will not capture the images of the top of each train car or the upper two-thirds of each train car.

The components of the train on the sides of each train car include the wheels, the bearings, and the truck of the train to name just two items. The truck of the train is the portion of the train that is positioned over the wheels of the train car. Some of the components that are on the underside of each train car that are captured include pins, couplers and hose connections to name a few.

The device can be moved from place to place and positioned quickly and efficiently. Designed for quick installation, the device operates dependably across a broad range of temperatures, humidity levels, and adverse weather conditions. The device will consist of equipment-cameras and means of illumination that is mounted on supports proximate to the sides of the rails. A module that is positioned on the track surface between the rails will capture high resolution images of the components of the underside of each train car as it moves along the rails; the module will house cameras and means of illumination.

The speed of the train is calculated and cameras which are installed on the module that is placed on the tracks below the train capture high-resolution images of the underside components.

A pair of stanchions, which are placed proximate to the rails support the components of the device; the stanchions must be positioned at least four feet from the rail. A pair of stanchions are secured to supports but can be easily moved from location to location.

The stanchions should be positioned directly opposed to each other on opposite sides of the rails and in a line over the module that is on the ground surface between the rails.

Software will be included to calculate the speed of the train and operate the cameras and means of illumination. The real time images will then be transported to a remote location and analyzed by artificial intelligence to detect anomalies in the captured images. A human in the system will review the results of the artificial intelligence analysis to verify the result.

All the equipment that is used in this device will be stowed in a trailer, which contains a power source, and can be transported easily from place to place.

### BRIEF DESCRIPTION OF THE DRAWINGS

FIG. 1 is a perspective view of the stanchion.

FIG. 2 is a perspective view of the means of illumination.

FIG. 3 is a perspective view of the camera.

FIG. 4 is a perspective view of the module that is placed on the track between the rails.

FIG. 5 is a perspective view of the components of the items of the system installed proximate to the railroad track.

FIG. 6 is a block drawing of the components of this device.

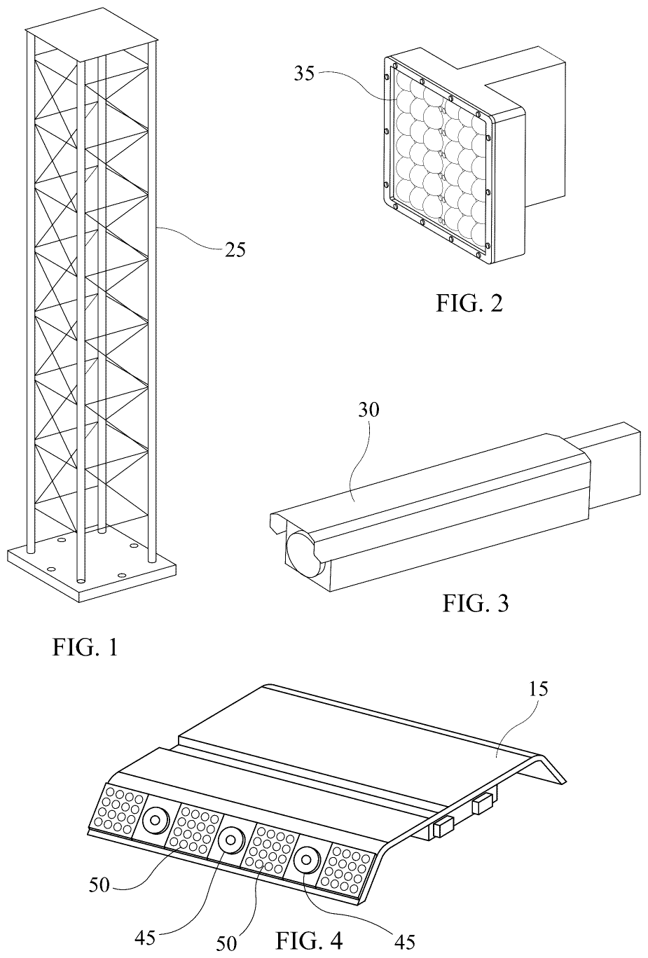

### NUMBERING REFERENCE

10 Rails
15 Module to Capture underside images
20 Stanchion Support
25 Stanchion
30 Stanchion Camera
35 Stanchion Camera Means of Illumination
40 Speed Detection Device
45 Module Cameras
50 Module Camera Illumination
55 Artificial Intelligence
60 Software

### DETAILED DESCRIPTION OF THE EMBODIMENTS

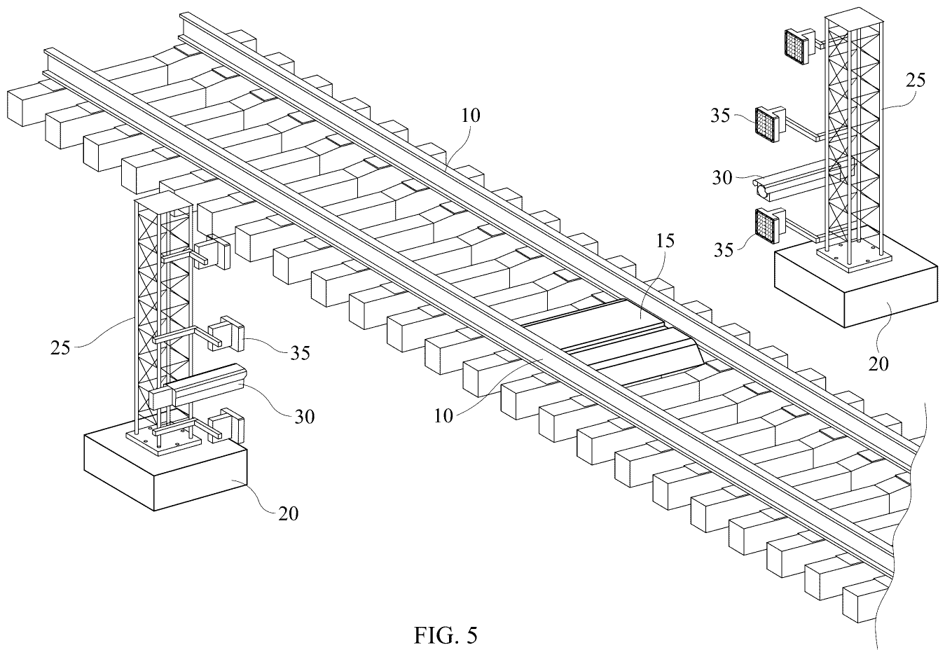

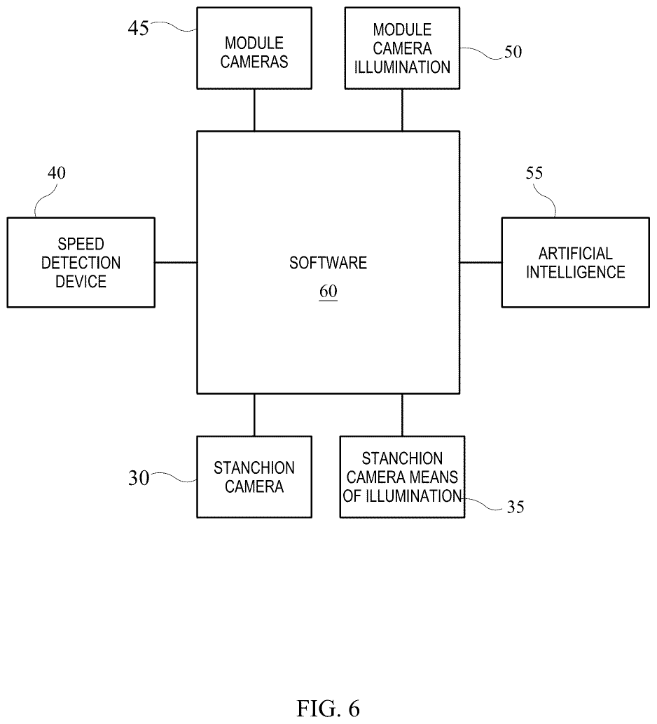

The train(not depicted)travels on a set of rails 10 as depicted in FIG. 5. Between the rails a module 15 is placed on the ground surface between the rails. The module 15 contains a plurality of cameras 45 and a means of illumination 50 to capture the images of the underside of the train as it passes over the module.

As the train approaches the module 15 the speed of the train 40 is calculated to sequence the cameras 45 and the means of illumination 50 in the module 15 to enable the device to capture high resolution images of the underside of each train car as it passes over the module. The modules are secured to the ground surface by looping connecting material (likely a chain) that is positioned under a rail tie. The connection material may loop under more than one rail tie. No specific connection material is claimed in this application; the connection material is included to ensure that the module remains at the appropriate level below the underside of a train and does not impact any part of the underside of the train.

A plurality of module cameras 45 and a means of illumination for the module 50 are placed in the module 15 to capture images of the underside of the train. The plurality of module cameras may be line scan or area scan cameras and the means of illumination for the module 50 means of illumination is likely to be light-emitting diode (LED) lighting although no specific means of illumination is being claimed. The module cameras 45 and the means of illumination on the module 50 are depicted in FIG. 4.

On either side of the rails are a pair of stanchions 25 on supports 20. The stanchions must be placed at least four feet away from the rail to comply with Federal regulations.

A means of illumination for the stanchions 35 is mounted to the respective stanchion 25 to illuminate the area as the train moves along the track on the rails 10. A stanchion camera 30 or multiple cameras is secured to the stanchion 25 and when deployed will capture high resolution images of the sides of each train car as the train passes by the stanchions 25.

The stanchions are placed in a straight line adjacent on either side of the rail 10 to the module 15 that is placed between the rails 10.

The means of illumination for the module 50 and the means of illumination for the stanchions 35 will operate in all environmental conditions and all temperature extremes. It is anticipated that the means of illumination will be comprised of LED lights.

The stanchion camera(s) 30 on the stanchions that captures the high-resolution images of the side of each train car will capture images of the lower one-third of the side of each train car. Some of the components (not an exhaustive list) that will be captured by the cameras include the wheels, bearing and truck assembly. The stanchion camera(s) is designed to operate in all environmental conditions and all lighting conditions. The plurality of stanchion cameras may be line cameras or area scan cameras or a combination of each type of camera.

The images of the side of each train car and images of the underside of each train are analyzed by artificial intelligence 55 to highlight possible anomalies or areas of concern for the customer.

All the components of this device can be stowed in a trailer (not depicted) which can be towed from position to position where an inspection may be needed. All the necessary cables and electrical connection equipment will be provided to connect the components of this application. A power source is included in the trailer to operate all the components of the device.

1. A portable rail inspection portal to capture high resolution images of a moving train which is comprised of:
a pair of stanchions,
wherein the pair of stanchions are portable,
a pair of stanchion supports,
wherein the stanchion supports are portable,
wherein the pair of stanchions are positioned on the pair of stanchion supports,
wherein the stanchions are positioned on opposite sides of the rails,
a module,
wherein the module is placed on the ground between the rails,
wherein the module is secured to the ground between the rails,
said module is further comprised of a plurality of module cameras and a means of illumination for the plurality of module cameras,
wherein the plurality of module cameras capture high resolution images of the underside of a train;
wherein the pair of stanchions are positioned opposite from each other on a straight line over the module,
a means of illumination on the stanchions,
a plurality of cameras on the stanchions,
wherein the plurality of cameras are mounted to the pair of stanchions,
wherein the plurality of cameras that are mounted to the pair of stanchions capture high resolution images of the lower one-third of the outside surface of the train car;
a speed detection device,
wherein the speed detection device is provided, said speed detection device calculates the speed of the moving train,
wherein the speed detection device is linked to the plurality of stanchion and module cameras,
wherein the speed detection device is linked to the plurality of the means of illumination for the module means of illumination and the means of illumination for the stanchion means of illumination,
software,
wherein the software compiles the captured high resolution images,
artificial intelligence,
wherein the artificial intelligence analyzes the high resolution images;
a trailer,
wherein the trailer is a predetermined size,
wherein the trailer houses the plurality of cameras,
wherein the trailer houses the stanchions,
wherein the trailer houses the modules,
wherein the trailer houses the means of illumination,
wherein the trailer houses the plurality of cameras,
wherein the trailer houses an independent power supply,
wherein the trailer houses the speed detection device,
wherein the independent power supply is portable.

2. A portable rail inspection portal to capture high resolution images of a moving train as described in claim 1, wherein the means of illumination for the module is light-emitting diode lighting.

3. A portable rail inspection portal to capture high resolution images of a moving train as described in claim 1, wherein the means of illumination on the stanchions is light-emitting diode lighting.

4. A portable rail inspection portal to capture high resolution images of a moving train as described in claim 1, wherein the module cameras are line scan cameras.

5. A portable rail inspection portal to capture high resolution images of a moving train as described in claim 1, wherein the module cameras are area scan cameras.

6. A portable rail inspection portal to capture high resolution images of a moving train as described in claim 1, wherein the cameras on the stanchions are line scan cameras.

7. A portable rail inspection portal to capture high resolution images of a moving train as described in claim 1, wherein the cameras on the stanchions are area scan cameras.
